(19) United States
(12) Patent Application Publication
(10) Pub. No.: US 2010/0116367 A1
(43) Pub. Date: May 13, 2010

(54) ON-OFF VALVE IN A FUEL DELIVERY MODULE AND METHOD FOR RETROFITTING THE FUEL DELIVERY MODULE

(76) Inventors: Martin Wierer, Ceske Budejovice (CZ); Michal Trnka, Hluboka Nad Vltavou (CZ); Zdenek Liner, Tyn Nad Vltavou (CZ); Dalibor Novak, Ceske Budejovice (CZ)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/596,599

(22) PCT Filed: Apr. 2, 2008
(86) PCT No.: PCT/EP2008/053924

§ 371 Date: Oct. 19, 2009

(30) Foreign Application Priority Data
Apr. 20, 2007 (DE) 102007018819.8

(51) Int. Cl. F16K 11/02; B23P 11/00

(52) U.S. Cl. 137/605; 29/401.1

(57) ABSTRACT

The control valve of the invention has two inlets and one outlet, where a first inlet and the outlet are provided at the front side and the second inlet at the circumference of the control valve. The inlets end in a valve chamber having a fluid connection to the outlet via a valve seat opening. The valve seat opening has a valve seat that can be closed with a valve body that is moveably arranged in a control valve. The outlet extends into the valve chamber with a valve seat section. A radial gap is provided between the valve seat section and a peripheral wall of the valve chamber. The control valve is suitable to be retrofitted to a reservoir pan in order to secure the fuel supply of a single-stage delivery assembly in each operational state when a two-stage delivery assembly is replaced by a single-stage delivery assembly. The control valve comprises a separate valve housing, which is designed such that it can be inserted and fastened in a cylindrical opening.

### PRIOR ART

The invention is based on an on-off valve as defined by claim 1 and on a fuel delivery module as defined by claim 8.

Fuel delivery modules are already known that have a reservoir pan and a two-stage delivery assembly disposed in the reservoir pan; with a first delivery stage, the delivery assembly aspirates fuel from a fuel tank into the reservoir pan, and with the second delivery stage, it draws fuel from the reservoir pan and delivers it, with increased pressure, via a pressure line to an internal combustion engine. It is disadvantageous that the two-stage delivery assembly cannot be replaced by a single-stage delivery assembly, since in that case there would be no active filling of the reservoir pan, which assures the fuel supply of the single-stage delivery assembly especially during cornering and while traveling on hills.

A fuel delivery module is already known from German Patent Disclosure DE 38 27 572 A1, having a single-stage delivery assembly, disposed in a reservoir pan, that aspirates fuel directly from the fuel tank via an on-off valve, and at low fill levels and/or when cornering or traveling on hills, the on-off valve switches over in such a way that fuel is aspirated from the reservoir pan. In this way, the active filling of the reservoir pan, which in the prior art is achieved with a first delivery stage of the delivery assembly or alternatively with a suction jet pump, is dispensed with. The on-off valve has two inlets and one outlet, and a first inlet and the outlet are provided on the face end and a second outlet is provided on the circumference of the on-off valve. The inlets discharge into a valve chamber, which can be made to communicate fluidically with the outlet via a valve seat opening, and the valve seat opening has a valve seat that is closable with a valve body disposed movably in the on-off valve, and the outlet protrudes with a valve seat portion into the valve chamber, and there is a radial gap provided between the valve seat portion and a circumferential wall of the valve chamber. It is disadvantageous that the on-off valve is integrated with the reservoir pan and is not suitable for retrofitting from a two-stage to a single-stage delivery assembly.

### ADVANTAGES OF THE INVENTION

The on-off valve according to the invention having the characteristics of claim 1 has the advantage over the prior art that it is suitable for being retrofitted on a reservoir pan, in order upon replacement of a two-stage delivery assembly with a single-stage delivery assembly to assure the fuel supply of the single-stage delivery assembly in every operating state. This is attained according to the invention in that the on-off valve has its own, separate valve housing, which is embodied such that it can be inserted into and secured in a cylindrical opening of the reservoir pan. In this way, the on-off valve is embodied on the order of a cartridge. The cylindrical opening of the reservoir pan is embodied as originally empty, that is, without built-in fixtures, and serves the purpose of directly aspirating fuel through the first delivery stage of the two-stage delivery assembly.

By the provisions recited in the dependent claims, advantageous refinements of and improvements to the on-off valve defined by claim 1 and the fuel delivery module defined by claim 7 are possible.

In one advantageous embodiment, the valve housing has snap hooks, which are lockable in the cylindrical opening.

It is especially advantageous if the valve seat portion widens continuously or in stepped fashion toward the valve seat, since in this way an extremely narrow radial gap is formed on the valve seat and creates a predetermined pressure loss. As a result of the embodiment of the extremely small radial gap, a predetermined pressure profile at the valve body can be established that should be embodied as symmetrically as possible, in order to achieve a stable, horizontal position of the flat valve body.

It is furthermore advantageous if a further valve seat with a further valve seat opening is provided, and the valve body is disposed movably between the valve seat and the further valve seat in such a manner that either the first inlet or the second inlet communicates fluidically with the outlet, and a connecting part of a prefilter, on which the further valve seat is embodied, is disposed at the first inlet. By the embodiment of the further valve seat on a separate part, the on-off valve can be produced especially economically.

It is highly advantageous if the valve body protrudes past the valve seat radially with regard to a valve axis and has a through opening, since in this way, two fluidic communications can be selected with a single valve body.

### DRAWINGS

One exemplary embodiment of the invention is shown in simplified form in the drawings and is explained in further detail in the ensuing description.

FIG. 1 shows an on-off valve of the invention in section; and

FIG. 2 shows the on-off valve of the invention of FIG. 1 in section, in a fuel delivery module.

### DESCRIPTION OF THE EXEMPLARY EMBODIMENT

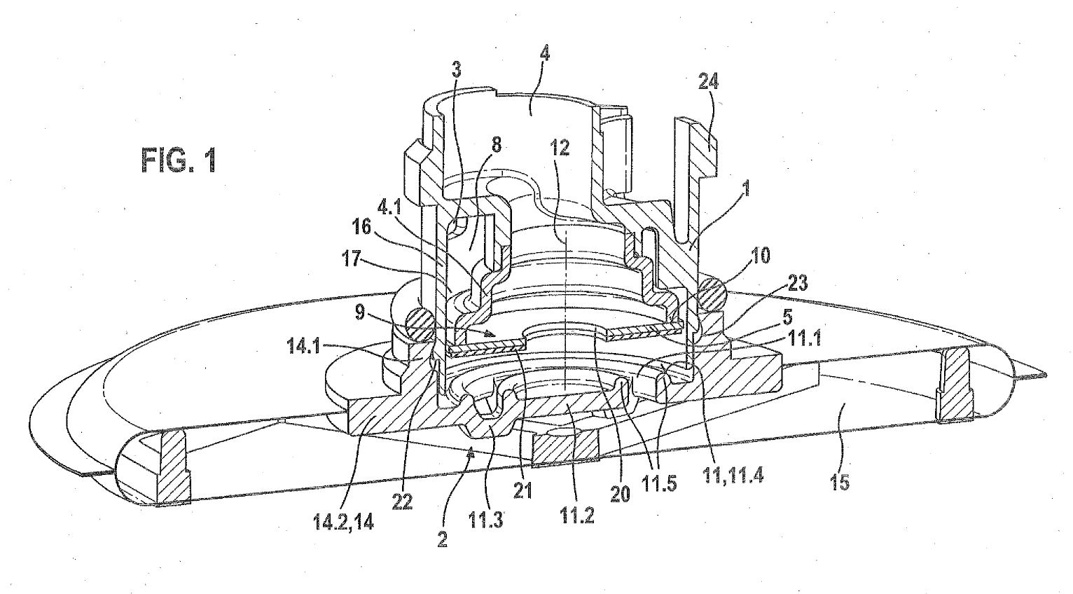

FIG. 1 shows an on-off valve of the invention in simplified faint, in section.

In an apparatus for delivering fuel, the on-off valve serves to control the fuel aspiration by a delivery assembly in such a way that fuel is aspirated either from a fuel tank or from a reservoir that is disposed in a fuel tank and is constantly filled via a fuel return. If the fill level in the fuel tank is sufficient, the delivery assembly aspirates the fuel from the fuel tank, and if the fill level is too low, it aspirates it from the reservoir. The switchover between the two switching positions is effected automatically, or in other words without external energy.

The on-off valve has a valve housing 1 with two inlets 2, 3 and one outlet 4, and a valve body 5 is provided, which as a function of a fill level in the fuel tank fluidically connects either the first inlet 2 or the second inlet 3 with the outlet 4. The valve housing 1 is embodied at least in some portions as cylindrical, sleevelike or cartridgelike, and the first inlet 2 is embodied on one face end, the outlet 4 is embodied on the opposite face end, and the second inlet is embodied on the circumference of the valve housing 1. The inlets 2, 3 discharge into a valve chamber 8, which can be made to communicate fluidically with the outlet 4 via a valve seat opening 9. The valve seat opening 9 has a valve seat 10, which is closable with the valve body 5 that is disposed movably in the valve chamber 8.

At the first inlet 2, a further valve seat 11 is provided, which likewise cooperates with the valve body 5. The valve body 5 is disposed axially movably between the valve seat 10 and the further valve seat 11 relative to a valve axis 12. The further valve seat 11 is provided for instance as a separate part in the valve housing 1. In the exemplary embodiment, the further valve seat 11 is embodied on a connecting part 14 of a prefilter 15 which communicates with the first inlet 2 of the valve housing 1.

The on-off valve is embodied such that upon contact of the valve body 5 with the valve seat 10, the first inlet 2 communicates fluidically with the outlet 4, and upon contact of the valve body 5 with the further valve seat 11, the second inlet 3 communicates fluidically with the outlet 4, and the first inlet 2 is closed.

The outlet 4 protrudes with a valve seat portion 4.1 into the valve chamber 8, and a radial gap 17 is provided between the valve seat portion 4.1 and a circumferential wall 16 that radially defines the valve chamber 8. The radial gap 17 extends over at least part of the circumference of the valve chamber 8, and for instance over the entire circumference. The valve seat portion 4.1 is embodied as a separate part, for example.

The second inlet 3 is disposed such that it discharges into the radial gap 17 between the circumferential wall 16 of the valve housing 1 and the valve seat portion 4.1. In this way the first inlet 2 and the second inlet 3 are disposed relative to one another such that with a single valve body 5, a predetermined fluidic communication can be established between the inlet 2 or 3 and the outlet 4, with the respective other fluidic communication interrupted.

In the exemplary embodiment, the valve seat portion 4.1 widens continuously or in stepped fashion toward the valve seat 10, so that an extremely narrow radial gap 17 is formed, which upon the aspiration of fuel via the second inlet 3 toward the outlet 4 generates a predetermined pressure loss in the extremely narrow radial gap 17. The second inlet 3 is disposed upstream of the extremely narrow radial gap 17. The valve seat portion 4.1 could also have a constant diameter. The contour, which for instance is stepped, of the valve seat portion 4.1 is embodied on both the inner circumference and the outer circumference.

The valve body 5 protrudes past the valve seat 10 in the radial direction relative to the valve axis 12, in such a way that upon contact of the valve body 5 with the valve seat 10, the radial gap 17 is substantially covered. A predetermined radial play is provided between the circumferential wall 16 and the valve body 5 so that the valve body 5 does not become canted in the course of its reciprocating motion. The result is a slight flow of leakage fuel from the second inlet 3 into the outlet 4, when the first inlet 2 is in fluidic communication with the outlet 4.

In order for the outlet 4 to open for the first inlet 2 in the upper valve position, that is, upon contact of the valve body 5 with the valve seat 10, the valve body 5 has at least one through opening 20, radially inside the valve seat 10. In the upper valve position, the second inlet 3 is essentially closed, so that the fuel is aspirated essentially directly from the fuel tank. In the lower valve position, that is, upon contact of the valve body 5 with the further valve seat 11, the first inlet 2 is tightly closed, so that fuel is aspirated only from the reservoir via the second inlet 3, and the fuel flows via the extremely narrow radial gap 17 and is deflected by approximately 180° and then reaches the outlet 4 via the valve seat opening 9. The further valve seat 11 is embodied such that upon contact of the valve body 5 with the further valve seat 11, the through opening 20 is tightly closed. The further valve seat 11 has at least one further valve seat opening 11.1, which is for instance embodied as crescent-shaped, in split ring fashion or annularly. The annular shape of the further valve seat 11 is formed for instance because a disklike valve seat body 112 is disposed centrally in the circular further valve seat opening 11.1, the diameter of this body being less than the diameter of the further valve seat opening 11.1 and this body being connected by means of ribs 11.3 to one edge 11.4 of the further valve seat opening 11.1. One annularly encompassing collar 11.5 is provided on each of the two edges of the annular further valve seat openings 11.1, 11.2, and in the lower valve position the valve body 5 comes to rest on this collar. The through opening 20 is disposed for instance radially inside the further valve seat opening 11.1.

The valve body 5 is embodied for instance as disklike and flat. It can be made from a metal or plastic, for example. On the side remote from the valve seat 10, the valve body 5 has a sealing means 21, which is embodied for instance as a flat seal, a layer, or a coating and which is solidly connected to the valve body 5. In this way, the further valve seat 11 closes tightly upon contact with the valve body 5. The sealing means 21 is made for instance from rubber or elastic plastic.

The valve housing 1 protrudes with its end portion oriented toward the first inlet 2 into a cylindrical portion 14.1 of the connecting part 14 and is connected to it. In the exemplary embodiment, a snap or detent connection is provided; for instance, an annular bead 22 is embodied on the outer circumference of the valve housing 1 and snaps into place into a complementary indentation 23 on the inside circumference of the cylindrical portion 14.1 of the connecting part 14. It is understood that some other type of connection, such as a press-fit or welded connection, would also be possible. On the cylindrical portion 14.1, a flange portion 14.2 is provided, which extends in the radial direction relative to the valve axis 12. Radially inside the cylindrical portion 14.1, the further valve seat 11 having the further valve seat opening 11.1 is embodied on the connecting part 14.

On the end portion oriented toward the outlet 4, the valve housing 1 also has a snap or detent connection for connecting to a fuel delivery module. For this purpose, snap hooks 24 are for instance embodied, which are distributed over the circumference of the end portion.

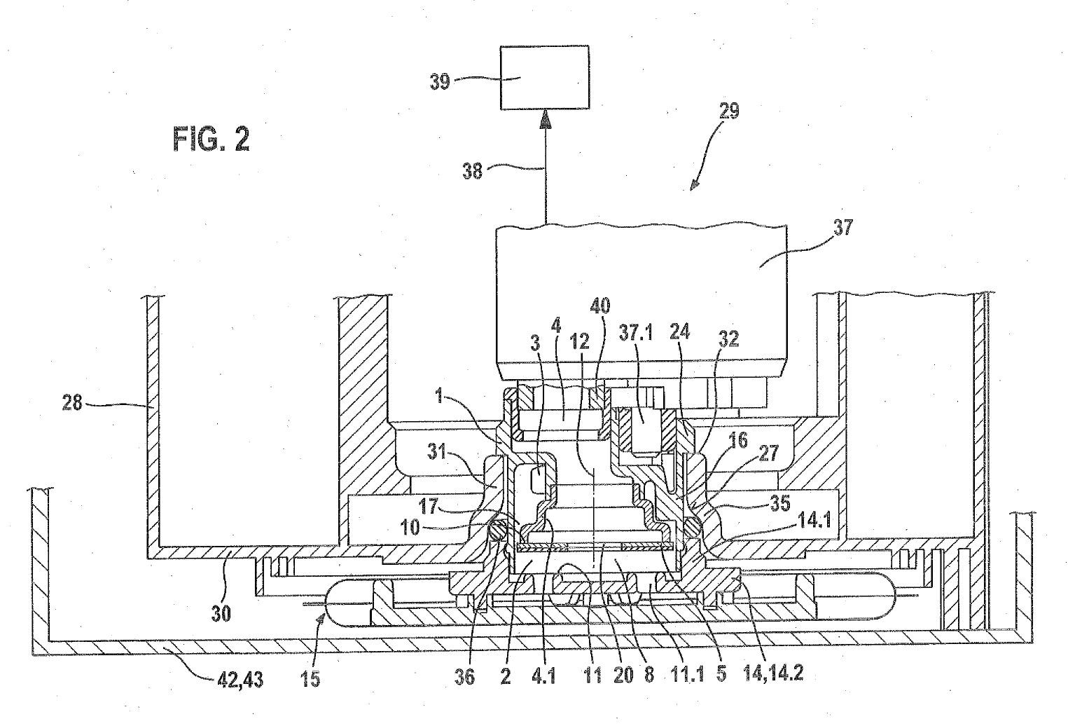

FIG. 2, in section, shows the on-off valve of FIG. 1, secured in an intake opening of a reservoir pan of a fuel delivery module.

In the fuel delivery module of FIG. 2, those parts that are the same or function the same as in the on-off valve of FIG. 1 are identified by the same reference numerals.

According to the invention, it is provided that the on-off valve has its own, separate valve housing 1, which is embodied such that it can be inserted into and secured in the intake opening 27 of a reservoir pan 28 of a fuel delivery module 29. In this way, an on-off valve that was not originally provided on the reservoir pan 28 is can be provided by retrofitting. A delivery assembly 37 is provided in the reservoir pan 28 of the fuel delivery module 29; it aspirates fuel via the on-off valve 1 and delivers it, with elevated pressure, via a pressure line 38 to an internal combustion engine 39. With an intake stub 40, the delivery assembly 37 protrudes into the outlet 4 of the on-off valve. However, the outlet 4 of the on-off valve can also extend into an inlet of the delivery assembly. The fuel delivery module 29 is disposed on the bottom 42 of a fuel tank 43.

From outside, that is, from the side of the reservoir pan 28 toward the fuel tank, the on-off valve of the invention is inserted, with the end portion toward the outlet 4 leading, into the intake opening 27 of the reservoir pan 28 that is part of the fuel delivery module 29. As a result of this retrofitting of the reservoir pan 28, it is possible, in a fuel delivery module originally equipped with a two-stage delivery assembly, to use a single-stage delivery assembly.

The intake opening 27 is provided in the bottom 30 of the reservoir pan 28 and for instance has an annular collar 31 that protrudes into the reservoir pan 28. The on-off valve is inserted into the intake opening 27 in such a way that the snap hooks 24 engage a collar rim 32 of the annular collar 31 from behind and in this way lock the on-off valve. The annular collar 31 has a shoulder 35, for example. A sealing ring 36 is provided on the outer circumference of the valve housing 1; viewed in the axial direction, it is disposed between the cylindrical portion 14.1 of the connecting part 14 and the shoulder 35 of the annular collar 31 of the intake opening 27.

For example, at least one snap hook 24 of the on-off valve is locked by the mounting of the delivery assembly 37 in the reservoir pan 28, in that a bearing journal 37.1 of the delivery assembly 37 protrudes into an interstice between the snap hook 24 and the outlet 4 and blocks any possible inward yielding of the snap hook 24.

1-9. (canceled)

11. An on-off valve having two inlets and one outlet, in which a first inlet and the outlet are provided on opposite face ends and a second inlet is provided on a circumference of the on-off valve, and the inlets discharge into a valve chamber which can be made to communicate fluidically with the outlet via a valve seat opening, and the valve seat opening has a valve seat that cooperates with a valve body disposed movably in the on-off valve, and the outlet protrudes with a valve seat portion into the valve chamber, and a radial gap is provided between the valve seat portion and a circumferential wall of the valve chamber, and the second inlet is disposed such that it discharges into the radial gap, wherein the on-off valve has a separate valve housing, which is embodied such that it is insertable into and securable in a cylindrical opening.

11. The on-off valve as defined by claim 10, wherein the valve housing has snap hooks, which are lockable in the cylindrical opening.

12. The on-off valve as defined by claim 10, wherein the valve seat portion widens continuously or in stages toward the valve seat.

13. The on-off valve as defined by claim 10, wherein the valve seat portion is embodied as a separate part.

14. The on-off valve as defined by claim 10, wherein a further valve seat with a further valve seat opening is provided, and the valve body is disposed movably between the valve seat and the further valve seat in such a manner that either the first inlet or the second inlet communicates fluidically with the outlet, and a connecting part of a prefilter, on which the further valve seat is embodied, is disposed at the first inlet.

15. The on-off valve as defined by claim 10, wherein the valve body protrudes radially past the valve seat with respect to a valve axis and has a through opening.

16. A fuel delivery module having a reservoir pan, a delivery assembly disposed therein, an intake opening in the reservoir pan, and an on-off valve, wherein a on-off valve as defined by claim 10 is provided in the intake opening of the reservoir pan.

17. A fuel delivery module having a reservoir pan, a delivery assembly disposed therein, an intake opening in the reservoir pan, and an on-off valve, wherein a on-off valve as defined by claim 11 is provided in the intake opening of the reservoir pan.

18. A fuel delivery module having a reservoir pan, a delivery assembly disposed therein, an intake opening in the reservoir pan, and an on-off valve, wherein a on-off valve as defined by claim 12 is provided in the intake opening of the reservoir pan.

19. A fuel delivery module having a reservoir pan, a delivery assembly disposed therein, an intake opening in the reservoir pan, and an on-off valve, wherein a on-off valve as defined by claim 13 is provided in the intake opening of the reservoir pan.

20. A fuel delivery module having a reservoir pan, a delivery assembly disposed therein, an intake opening in the reservoir pan, and an on-off valve, wherein a on-off valve as defined by claim 14 is provided in the intake opening of the reservoir pan.

21. A fuel delivery module having a reservoir pan, a delivery assembly disposed therein, an intake opening in the reservoir pan, and an on-off valve, wherein a on-off valve as defined by claim 15 is provided in the intake opening of the reservoir pan.

22. The fuel delivery module as defined by claim 17, wherein the intake opening of the reservoir pan is embodied as an annular collar, which protrudes into the reservoir pan and has a collar rim, and the snap hooks engage the collar rim from behind.

23. A method for retrofitting a fuel delivery module with a reservoir pan and a two-stage delivery assembly disposed in the reservoir pan, having an intake opening provided in the reservoir pan, by way of which opening fuel can be aspirated into the reservoir pan by a first delivery stage of the delivery assembly, wherein the delivery assembly is replaced by a single-stage delivery assembly, and an on-off valve as defined by claim 10 is disposed in the intake opening.

24. A method for retrofitting a fuel delivery module with a reservoir pan and a two-stage delivery assembly disposed in the reservoir pan, having an intake opening provided in the reservoir pan, by way of which opening fuel can be aspirated into the reservoir pan by a first delivery stage of the delivery assembly, wherein the delivery assembly is replaced by a single-stage delivery assembly, and an on-off valve as defined by claim 11 is disposed in the intake opening.

25. A method for retrofitting a fuel delivery module with a reservoir pan and a two-stage delivery assembly disposed in the reservoir pan, having an intake opening provided in the reservoir pan, by way of which opening fuel can be aspirated into the reservoir pan by a first delivery stage of the delivery assembly, wherein the delivery assembly is replaced by a single-stage delivery assembly, and an on-off valve as defined by claim 12 is disposed in the intake opening.

26. A method for retrofitting a fuel delivery module with a reservoir pan and a two-stage delivery assembly disposed in the reservoir pan, having an intake opening provided in the reservoir pan, by way of which opening fuel can be aspirated into the reservoir pan by a first delivery stage of the delivery assembly, wherein the delivery assembly is replaced by a single-stage delivery assembly, and an on-off valve as defined by claim 13 is disposed in the intake opening.

27. A method for retrofitting a fuel delivery module with a reservoir pan and a two-stage delivery assembly disposed in the reservoir pan, having an intake opening provided in the reservoir pan, by way of which opening fuel can be aspirated into the reservoir pan by a first delivery stage of the delivery assembly, wherein the delivery assembly is replaced by a single-stage delivery assembly, and an on-off valve as defined by claim 14 is disposed in the intake opening.

28. A method for retrofitting a fuel delivery module with a reservoir pan and a two-stage delivery assembly disposed in the reservoir pan, having an intake opening provided in the reservoir pan, by way of which opening fuel can be aspirated into the reservoir pan by a first delivery stage of the delivery assembly, wherein the delivery assembly is replaced by a single-stage delivery assembly, and an on-off valve as defined by claim 15 is disposed in the intake opening.
